(19) United States
(12) Patent Application Publication
(10) Pub. No.: US 2019/0273452 A1
(43) Pub. Date: Sep. 5, 2019

(54) ELECTROMAGNETIC VIBRATION ENERGY HARVESTER FOR URBAN RAIL TRANSIT BRIDGE HEALTH MONITORING

(71) Applicant: Central South University, Changsha (CN)

(72) Inventors: Wenqi HOU, Changsha (CN); Yankun LI, Changsha (CN); Wei GUO, Changsha (CN); Xiaoxu DUAN, Changsha (CN)

(21) Appl. No.: 16/259,698

(22) Filed: Jan. 28, 2019

(30) Foreign Application Priority Data
Mar. 1, 2018 (CN) 201810172221.5

(51) Int. Cl. H02N 2/18

(52) U.S. Cl. CPC H02N 2/186

(57) ABSTRACT

An electromagnetic vibration energy harvester for urban rail transit bridge health monitoring includes a housing, and a spring component, a mass block, a coils and two permanent magnets arranged in the housing. The spring component, two permanent magnets are provided with opposite poles facing each other. The spring component is provided between the two permanent magnets. The coils are provided in the upper end of the spring component; the mass block is provided in the coils. The mass block, coils, the total stiffness of the spring component and the natural frequency of the energy harvester satisfy the equation: ƒ=(k/4mπ²)^{1/2} where m is the mass of the mass block (unit: kg); k is the total stiffness of the spring component (unit: kN/m); ƒ is the natural frequency of the energy harvester with the value ranging from 5-6 Hz.

### CROSS-REFERENCE TO RELATED APPLICATIONS

This application claims the benefit of priority from Chinese Patent Application No. CN 201810172221.5, filed on Mar. 1, 2018. The content of the aforementioned application, including any intervening amendments thereto, is incorporated herein by reference in its entirety.

### TECHNICAL FIELD

The present invention relates to self-power supplies for bridge health monitoring, and in particular to an electromagnetic vibration energy harvester for urban rail transit bridge health monitoring.

### BACKGROUND OF THE INVENTION

Segmental prefabricated assembled (SPA) bridges, as rapid construction bridges, have been more and more widely used in the elevated urban mass transit. As compared to the traditional cast-in-place bridges, SPA bridges have the advantages of being environmentally friendly, energy saving and high efficiency. However, the section stiffness and durability of the segmental prefabricated bridges have always been the focus of attention due to the joints therein. In order to ensure the normal operation of a bridge, long-term health monitoring of the bridge is necessary. Usually, embedded sensors are needed for bridge health monitoring. For various power supply of the embedded sensors, persistence and stability are the key points.

In view of the above, a research tends to harvest the energy of mechanical vibration generated by the bridge vibration, and then convert this mechanical energy into usable electrical energy to supply the embedded sensors. This type of power supply is affected by the different harvesters, resulting in different efficiency. According to the principle of the transformation of vibration energy, the vibration energy devices can be divided into Piezoelectric Vibration Energy Harvesters (PE-VEHs), Electrostatic Vibration Energy Harvesters (ES-VEHs) and Electromagnetic Vibration Energy Harvesters (EM-VEHs). Among them, ES-VEH is limited by structural design, which requires a battery source for the continuous charging of the plates of the harvesters and also an energy extraction circuit (switching circuit) to collect the harvested energy. For PE-VEHs, the piezoelectric material has great influence on the performances of the device, and its power density is higher, so it is more suitable for the micro scale system. While, for EM-VEHs, the static gain, natural frequency and damping factor can be adjusted by the structural parameters of the device, and the power of the device is higher, so it is more suitable for the medium scale system such as civil structure.

Electromagnetic vibration energy harvesters (EM-VEHs) work according to the principle of Faraday's law of electromagnetic induction. When the magnetic flux density passing through the loop region changes, the electromagnetic induction energy is induced in the closed loop coils. In general, the EM-VEH consist of permanent magnets, coils and spring systems (as shown in FIG. 1). When the EM-VEH is excited by external excitation, the magnetic flux of the wound coils varies with the vibrating motion of the EM-VEH, and electro-motive force is generated. Namely, the conversion from vibration energy to electrical energy has been processed.

The vibration of the elevated urban rail transit bridge caused by running vehicle is mainly low-frequency, generally about 2-10 Hz. Currently, the research on EM-VEH under low frequency state (≤10 Hz) shows that these harvesters have a lower power output density with no more than 50 μW/cm³, leading to undesired harvesting efficiency. In addition, most of EM-VEHs are in the laboratory stage with complex production process, such that the cost of power supply for health monitoring sensors is higher, and it is difficult to popularize the products.

### SUMMARY OF THE INVENTION

The new proposed EM-VEH is to solve the existing technical problem that the EM-VEH applied to urban rail transit bridge health monitoring has low energy harvesting efficiency, low output power and low power output density.

In order to achieve the above object, the invention provides an electromagnetic vibration energy harvester for urban rail transit bridge health monitoring, including a housing, a spring component, a mass block, coils and two permanent magnets placed in the housing. The different poles of the two permanent magnets are arranged opposite to each other. The spring component is arranged between the two permanent magnets. The upper end of the spring component is provided with the coils. The mass block is arranged in the coils.

The mass of the mass block, the total stiffness of the spring component and the natural frequency of the energy harvester satisfy the following equation:

ƒ(k/4mπ²)^{1/2}

wherein, m is the mass of the mass block (unit: kg); k is the total stiffness of the spring component (unit: kN/m); ƒ is the natural frequency of the energy harvester with a value ranging from 5-6 Hz.

Further, the mass of the mass block is 1400-1600 kg, the total stiffness of the spring component is 1800-1808 kN/m, the height of the two permanent magnets is 0.18-0.22 m; when the EM-VEH is not working, the height from the bottom centerline of the coils to the bottom plate of the housing is 0.09-0.11 m.

Further, the distance from the top centerline of the coils to the bottom centerline is 0.38-0.42 m.

Further, the permanent magnet is AlNiCo magnet with a residual magnetic density of 0.5-0.7 T.

Further, the distance from the outermost side of the coils to the more proximal side surface of the permanent magnet is 4-6 mm.

Further, the energy harvester includes a fixing frame, wherein the bottom of the fixing frame is connected to the upper end of the spring component, the mass block is provided in the fixing frame, the coils are wound around the periphery of the mass block and placed on the fixing frame.

Further, the energy harvester includes a plurality of struts. The plurality of struts are vertically provided between the two permanent magnets. The upper end of each strut is connected to a top of the housing, and the lower end of each strut is welded to the bottom plate of the housing. The fixing frame is arranged on the struts in a sliding manner, and the spring component is sleeved on the lower end of the struts.

Further, two wires for supplying power to the health monitoring component are connected to the coils.

Further, the number of layers of the coils is 18-22, the number of turns of each layer is 580-620, the coils adopts copper wires, and the radius of a single copper wire is 0.4-0.6 mm.

Further, a plurality of bolts for fixing the energy harvester to the bridge structure are provided on the bottom plate of the housing.

The electromagnetic vibration energy harvester applying the technical scheme of the present invention optimizes, according to the relationship between mass, stiffness and frequency in a single degree of freedom vibration system: ƒ=(k/4mπ²)^{1/2}, where the mass m of the mass block and the total stiffness k of the spring component, such that the natural frequency ƒ of the energy harvester is close to the most contributing frequency ƒₑ of the vibration of urban rail transit bridge caused by running vehicle. In this way, the device resonates with the bridge excitation vibration, and the electric energy storage efficiency, output power, and power output density of the energy harvester are improved.

The invention now will be described in detail with reference to the drawings.

### BRIEF DESCRIPTION OF THE DRAWINGS

The drawings of the description constituting a part of the present application are used to provide further understanding of the prevent invention, the illustrative embodiments of the present invention and the explanations thereof for explaining the present invention do not constitute undue limitations on the present invention. In the drawings:

FIG. 1 is a schematic diagram of an electromagnetic vibration energy harvester.

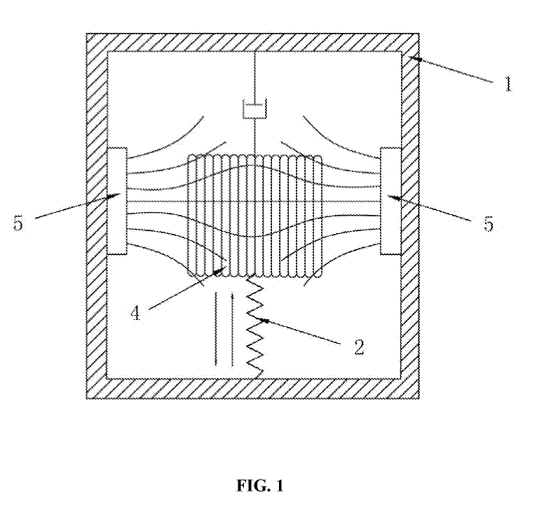

FIG. 2 is a schematic diagram of an electromagnetic vibration energy harvester of the present invention.

FIG. 3 is a schematic diagram showing the installation position of the electromagnetic vibration energy harvester of the present invention.

FIG. 4 is a graph showing an output power curve of the electromagnetic vibration energy harvester of the present invention.

### REFERENCE NUMERALS

1, housing; 2, spring component; 3, mass block; 4, coils; 5, permanent magnet; 6, fixing frame; 7, strut; 8, wire; 9, bolt; 10, bridge; 11, track slab.

### DETAILED DESCRIPTION OF THE INVENTION

In order to facilitate the understanding of the present invention, the present invention will be described more fully and in detail with reference to the accompanying drawings and preferred embodiments, but the scope of the invention is not limited to the following specific embodiments.

Unless otherwise specified, the terminology used hereinafter has the same meaning as commonly understood by those skilled in the art. Similar terms such as “a” or “an” used in the description and claims of the present patent application do not limit the number of element(s), indicating there are at least one element. Similar terms such as “connecting” or “connected” are not limited to physical or mechanical connections in a direct or indirect manner. “Up”, “down”, “left”, “right” and so on are only used to represent the relative position relationship. When the absolute position of an object is changed, the relative position relationship will change accordingly.

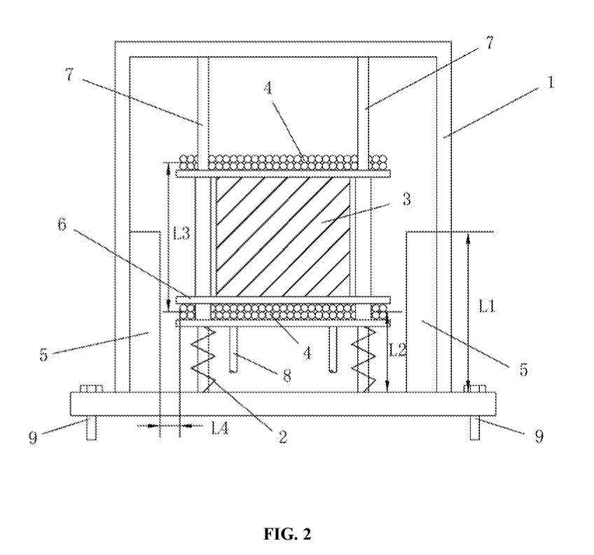

Referring to FIG. 2, an electromagnetic vibration energy harvester for urban rail transit bridge health monitoring of the present invention includes a housing 1 in which a spring component 2, a mass block 3, coils 4 and two permanent magnets 5 are provided. The inside of the housing 1 is in a vacuum state. The two permanent magnets 5 with opposite poles facing each other are arranged in the housing 1.

The spring component 2, the mass block 3 and the coils 4 each are provided between the two permanent magnets 5. The lower end of the spring component 2 is fixed on the inner side of the bottom plate of the housing 1, the coils 4 are installed on the upper end thereof, and the mass block 3 is provided in the coils 4. The mass block 3, the spring component 2 and the permanent magnets 5 constitute a “mass-spring-damping” single degree of freedom vibration system.

It is found, through research and analysis, that when the vehicle passes an urban rail transit bridge, the most contributing frequency value ƒₑ of the vibration at the track slab on the bridge span is about 5.5 Hz, and the proposed EM-VEH invention makes the natural frequency of the energy harvester be close to the most contributing frequency value ƒₑ of the vibration of urban rail transit bridge caused by running vehicle, by adjusting the mass of the mass block 3 and the total stiffness of the spring component 4, thereby realizing the maximum energy storage efficiency of the EM-VEH, improving the electric energy storage efficiency of the energy harvester, and improving the output power and power output density.

Referring to FIG. 2, in order to further improve the electric energy storage efficiency of the energy harvester, the height L1 of the two permanent magnets 5 is set to 0.18-0.22 m, preferably 0.2 m, and the height L2 from the bottom centerline of the coils 4 when the energy harvester is stationary to the inner side of the bottom plate of the housing 1 is set to 0.09 m-0.11 m, preferably 0.1 m. Thus, the bottom centerline of the coils 4 is just in the center the permanent magnet 5. The mass of the mass block 3 is set to 1400-1600 kg, further preferably 1500 kg, and the spring component 2 has a total stiffness of 1800-1808 kN/m, more preferably 1804 kN/m.

Referring to FIG. 2, in the present embodiment, the distance L3 from the top centerline to the bottom centerline of the coils 4 is 0.38 m-0.42 m, preferably 0.4 m; the distance L4 from the outermost side of the coils 4 to the more proximal side surface of the permanent magnet 5 is 4 mm-6 mm, preferably 5 mm; the number of layers of the coils 4 is 18-22, preferably 20. The number of turns of each layer is 580-620, preferably 600. The coils 4 are of copper wires, and the radius of a single copper wire is 0.4 mm-0.6 mm, preferably 0.5 mm. The permanent magnet 5 is an alnico (AlNiCo) magnet having a residual magnetic density of 0.5-0.7 T, preferably 0.6 T, and the size of the permanent magnet 5 is 0.2 m×0.2 m×0.03 m (length×width×thickness). The mass block 3 is a lead block having a size of 0.6 m×0.6 m×0.38 m (length×width×height). In this way, the heat energy loss generated by the coils of the energy harvester can be minimized, the electromagnetic damping can be optimized, and the electric energy storage efficiency of the energy harvester can be further improved.

Referring to FIG. 2, in the embodiment, the energy harvester further includes a fixing frame 6, the bottom of the fixing frame 6 is connected to the upper end of the spring component 2, the mass block 3 is provided in the fixing frame 6, the coils 4 are wound around the periphery of the mass block 3 and placed on the fixing frame 6. In this way, the installation of the mass block 3 and the coils 4 can be made more stable and the entirety is better.

Specifically, a plurality of struts 7 are provided in the housing 1. The struts 7 are vertically provided between the two permanent magnets 5. The upper end of the strut 7 is connected to the top of the housing 1, and the lower end of the strut 7 is welded to the bottom plate of the housing 1. The fixing frame 6 is arranged on the strut 7 in a sliding manner, and the spring component 2 is sleeved on the lower end of the strut 7. Thus, during operation, the mass block 3 and the coils 4 slide up and down along the struts 7 as a whole, and the vibration direction of the mass block 3 and the coils 4 is restrained by the struts 7 to form a single degree of freedom vibration model to enhance the stability of the energy harvester when vibrated.

Referring to FIG. 2, in the energy harvester, two wires 8 for supplying power to the health monitoring sensors are connected to the coils 4. The EM-VEH can output power up to 35 W in 7 min. A plurality of bolts 9 are provided on the bottom plate of the housing 1 for fixing the energy harvester to the bridge structure.

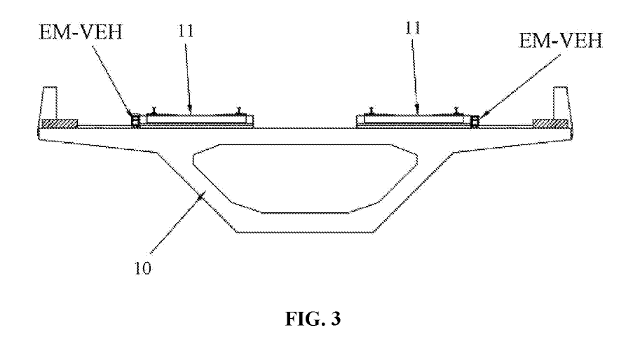

Referring to FIG. 3, in particular use, the energy harvester is placed on the outside of the track slab 11 on the bridge 10, and the energy harvester is fixedly installed on the track slab 11 by a plurality of bolts 9 provided on the bottom plate of the housing 1. The energy harvester is installed on the mid-span bridge 10 close to the track slab 11. When the train passes the bridge 10, the vibration of the track slab 11 is more intense than that of the bridge 10. Installing the energy harvester in such position can maximize its energy storage efficiency, increase its output power and power output density.

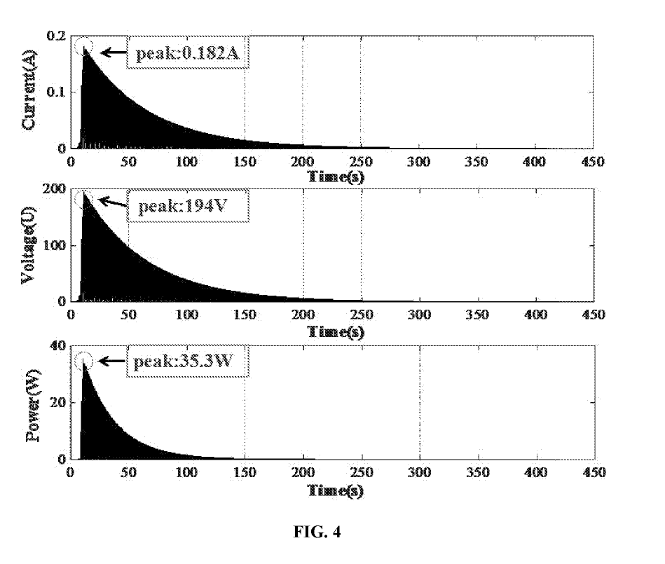

Referring to FIG. 4, the energy harvester of the embodiment is applied, and the device has an output power of up to 35 W in 7 min, an output voltage of up to 194 V, an output current of up to 0.182 A, and an average output power of 0.61 W. It can fully supply the power of a GPS data transmission unit with a working power of 0.5 W, achieving self-power supply in bridge health monitoring, reducing the cost of sensors power supply replacement or charging, and improving the energy utilization efficiency of the system. The energy harvester has a power output density of up to 176.5 μW/cm³, while most existing energy harvesters have a power output density of no more than 50 μW/cm³, so the EM-VEH of the present invention is much higher than that of the most existing similar devices.

The above description involves only preferred embodiments of the present invention, and is not intended to limit the present invention. For those skilled in the art, various modifications and changes may be made to the present invention. Any modifications, equivalent substitutions, improvements made within the spirit and scope of the present invention are intended to be included in the scope of the present invention.

What is claimed is:

1. An electromagnetic vibration energy harvester for urban rail transit bridge health monitoring, comprising:
a housing,
a spring component,
a mass block,
coils, and
two permanent magnets;
wherein the spring component, the mass block, the coils and the two permanent magnets are arranged in the housing;
wherein the two permanent magnets are provided with opposite poles facing each other; the spring component, the mass block and the coils each are provided between the two permanent magnets; a lower end of the spring component is fixed on a bottom plate of the housing, and the coils are provided in the upper end of the spring component; and the mass block is provided in the coils;
the mass of the mass block, the total stiffness of the spring component and the natural frequency of the energy harvester satisfy the following equation:
ƒ=(k/4mπ²)^{1/2}
where m is the mass of the mass block (unit: kg); k is the total stiffness of the spring component (unit: kN/m); ƒ is the natural frequency of the energy harvester with a value ranging from 5 to 6 Hz.

2. The electromagnetic vibration energy harvester according to claim 1, wherein the mass of the mass block is 1400-1600 kg, the total stiffness of the spring component is 1800-1808 kN/m, the height of the two permanent magnets is 0.18-0.22 m, and the height from the bottom centerline of the coils when the electromagnetic vibration energy harvester is stationary to the inner side of the bottom plate of the housing is 0.09-0.11 m.

3. The electromagnetic vibration energy harvester according to claim 1, wherein the distance from the top centerline of the coils to the bottom centerline is 0.38 m-0.42 m.

4. The electromagnetic vibration energy harvester according to claim 1, wherein the permanent magnet is an AlNiCo magnet with a residual magnetic density of 0.5-0.7 T.

5. The electromagnetic vibration energy harvester according to claim 1, wherein the distance from the outermost side of the coils to the more proximal side surface of the permanent magnet is 4-6 mm.

6. The electromagnetic vibration energy harvester according to claim 1, wherein the energy harvester further comprises a fixing frame; the bottom of the fixing frame is connected to the upper end of the spring component, the mass block is provided in the fixing frame, the coils are wound around a periphery of the mass block and placed on the fixing frame.

7. The electromagnetic vibration energy harvester according to claim 6, wherein the energy harvester further comprises a plurality of struts; the plurality of struts are vertically provided between the two permanent magnets, the upper end of each of the plurality of struts connected to the top of the housing, the lower end of each of the plurality of struts is welded to the bottom plate of the housing, the fixing frame is arranged on the struts in a sliding manner, and the spring component is sleeved on the lower end of the struts.

8. The electromagnetic vibration energy harvester according to claim 1, wherein two wires for supplying power to the health monitoring component are connected to the coils.

9. The electromagnetic vibration energy harvester according to claim 1, wherein the number of layers of the coils is 18-22, the number of turns of each layer is 580-620, the coils are of copper wires, and the radius of a single copper wire is 0.4 mm-0.6 mm.

10. The electromagnetic vibration energy harvester according to claim 1, wherein a plurality of bolts for fixing the electromagnetic vibration energy harvester to the bridge structure are provided on the bottom plate of the housing.
